(19) United States
(12) Patent Application Publication
(10) Pub. No.: US 2023/0073115 A1
(43) Pub. Date: Mar. 9, 2023

(54) Estimating a Cost to Repair a Damaged Item without Physically Inspecting the Item

(71) Applicant: Allstate Insurance Company, Northbrook, IL (US)

(72) Inventors: Randall Martin Hanson, Grayslake, IL (US); Joy Thomas, Glenview, IL (US); Eric Huls, Chicago, IL (US); Floyd Yager, Park Ridge, IL (US)

(21) Appl. No.: 14/562,036

(22) Filed: Dec. 5, 2014

Related U.S. Application Data
(63) Continuation-in-part of application No. 14/465,475, filed on Aug. 21, 2014.
Application No. 14/465,475 is a continuation of application No. 13/458,388, filed on Apr. 27, 2012, now Pat. No. 9,424,606.
(60) Provisional application No. 62/014,942, filed on Jun. 20, 2014.
(60) Provisional application No. 61/480,207, filed on Apr. 28, 2011.

(51) Int. Cl. G06Q 40/08; G06F 3/04842; G06Q 30/02

(52) U.S. Cl. CPC G06Q 40/08; G06F 3/04842; G06Q 30/0283

(57) ABSTRACT

Systems and computer-implemented methods for estimating a cost to repair a damaged item are provided. In some example implementations, an indication identifying a portion of the damaged item is received. A series of images are selected that depict increasing degrees of damage to a reference item at the portion identified, and the series of images are provided for presentation. An indication is received that identifies one of the images in the series of images that has been selected as best representing the damage to the portion of the damaged item identified. An estimated cost to repair the damaged item is generated based, at least in part, on the image selected.

### CROSS-REFERENCE TO RELATED APPLICATIONS

This application is a continuation-in-part of U.S. patent application Ser. No. 14/465,475 entitled “Streamlined Claims Processing” and filed on Aug. 24, 2014, which is a continuation in part of U.S. patent application Ser. No. 13/458,388 entitled “Enhanced Claims Settlement” and filed on Apr. 27, 2012, which claims the benefit of U.S. Provisional Patent Application No. 61/480,207 entitled “Enhanced Claims Settlement” and filed on Apr. 28, 2011, each of which are incorporated by reference herein in their entirety. U.S. patent application Ser. No. 14/465,475 also claims the benefit of U.S. Provisional Patent Application No. 62/014,942 entitled “Streamlined Claims Processing” and filed on Jun. 20, 2014, which is also incorporated by reference herein in its entirety.

### BACKGROUND

Handling insurance claims can be a time-consuming and complex process for both the claimant and the claims processor. The claimant often starts the process with a first notice of loss to a claims processing office associated with an insurance company. Usually, a claims adjuster within the claims processing office is assigned to the case to assess the damage for which compensation is sought. The claims adjustment process can involve paperwork processing, telephone calls, and potentially face-to-face meetings between claimant and adjuster. In addition, time can elapse between a first notice of loss from the claimant and the final settlement of the claim.

### SUMMARY

The following presents a simplified summary of the present disclosure in order to provide a basic understanding of some aspects of the disclosure. This summary is not an extensive overview of the disclosure. It is not intended to identify key or critical elements or to delineate the scope of the claimed subject matter. The following summary merely presents some concepts of the disclosure in a simplified form as a prelude to the more detailed description provided below.

A first aspect described herein provides a computer-implemented method of estimating a cost to repair a damaged item. In some example implementations, an indication identifying a portion of the damaged item is received. A series of images are selected that depict increasing degrees of damage to a reference item at the portion identified, and the series of images are provided for presentation. An indication is received that identifies one of the images in the series of images that has been selected as best representing the damage to the portion of the damaged item identified. An estimated cost to repair the damaged item is generated based, at least in part, on the image selected.

A second aspect described herein provides a system for estimating a cost to repair a damaged item. In some example embodiments, the system includes a data store, a damage information collection interface, and a repair cost generator. The data store stores a set of images depicting varying degrees of damage to at least one portion of a reference item. The damage collection interface is configured to receive an indication that identifies a portion of the damaged item and select from the set of images a series of images that depict increasing degrees of damage to the reference item at the portion identified. The damage collection interface is also configured to provide the series of images selected for presentation and receive an indication that identifies one of the images in the series of images that has been selected as best representing the damage to the portion identified. The repair cost generator is configured to generate an estimated cost to repair the damaged item based, at least in part, on the image selected.

In some example embodiments, metadata is stored for each image in the set of images. Such metadata includes an item type of the reference item depicted in the image, the type of damage depicted in the image, and an identifier of the portion of the reference item depicted in the image. Repair cost data is also be stored for each image in the set of images. The estimated cost to repair the damaged item is based on the repair cost data associated with the image selected. Multiple series of images may be selected that each depict increasing degrees of damage to respective portions of the damaged item. The estimated cost to repair the damaged item is thus determined by summing the repair cost data respectively associated with the images selected from each series of images as best representing the damage that occurred to the respective portions of the damaged item.

In some example embodiments, a subsequent image in the series of images depicts more damage to the reference item relative to a previous image in the series of images. The images in the series of images may depict increasing degrees of damage to an area of the reference item or to a component of the reference item. The series of images of the reference item may be a series of photos of the reference item or may be a series of graphical representations of the reference item. The damaged item and the reference item may be of the same type or different types. An item type of the damaged item may be automatically determined based on a notification received that indicates damage has occurred to the damaged item. A damage report may be generated for the damaged item that includes the image selected and the repair cost associated with the image selected.

The details of these and other embodiments of the disclosure are set forth in the accompanying drawings and description below. Other features and advantages of aspects of the disclosure will be apparent from the description, drawings, and claims.

### BRIEF DESCRIPTION OF THE DRAWINGS

The present disclosure is illustrated by way of example and is not limited in the accompanying figures in which like reference numerals indicate similar elements.

FIG. 1 is a block diagram of an operating environment in which various aspects of the disclosure may be implemented.

FIG. 2 is a block diagram of workstations and servers that may be used to implement the processes and functions of certain aspects of the present disclosure.

FIG. 3 is a block diagram of a workflow for using an enhanced claims processing server in accordance with at least one aspect of the present disclosure.

FIG. 4 is a block diagram of an example of an implementation of an enhanced claims processing apparatus in accordance with at least one aspect of the present disclosure.

FIG. 5 is a block diagram of the feedback loop provided by the enhanced claims processing system in accordance with at least one aspect of the present disclosure.

FIG. 6 is a block diagram of an example of an implementation of an enhanced claims processing system in accordance with at least one aspect of the present disclosure.

FIG. 7 is a flowchart of example method steps for using an enhanced claims processing system with a feedback loop in accordance with at least one aspect of the present disclosure.

FIG. 8 is a block diagram of an example of an implementation of a damage information collection device in accordance with at least one aspect of the present disclosure.

FIG. 9 is a block diagram of another example of an enhanced claims processing system in accordance with at least one aspect of the present disclosure.

FIG. 10 is a flowchart of example method steps for collecting damage information related to a damaged item in accordance with at least one aspect of the present disclosure.

### DETAILED DESCRIPTION

U.S. patent application Ser. No. 14/465,475—which the present application claims priority to as a continuation-in-part—discusses an enhanced claims settlement server that may receive information identifying the actual cost to repair damage associated with a damaged item. That application notes that the enhanced claims settlement server may utilize such information to generate a more accurate payment amount for future work orders. The present disclosure provides systems and methods for generating a non-negotiable payment amount to repair damage to an item based on feedback received from repair service providers indicating the actual cost to repair damaged items.

The feedback received from the repair service providers is added to a pool of actual repair cost data. A repair cost generator configures a repair cost model with damage information received from a claimant and actual repair cost data. The repair cost generator utilizes the repair cost model to generate a repair cost amount representing the cost to repair the damaged item. The repair cost amount maybe used to select a non-negotiable payment amount an insurance company pays to a repair service provider to repair the damage to the item. Repairing an item, as used in this description, includes: replacing the damaged item with a new item, replacing a portion of the damaged item, such as a part or component of the item, with a new portion (e.g., a new part or a new component); restoring the damaged item to the condition it was in before the damage occurred; and restoring a portion of the damaged item (e.g., a part or component) to the condition that portion was in before the damage occurred. Accordingly the feedback received from the repair service providers may include information related to the methodology applied to determine whether the item or a portion of the item should be replaced versus restored. The feedback received from the repair service providers may also include information related to the cost of individual parts replaced at the item as well as information related to the cost of labor when replacing or restoring the item.

A work order that details the damage to the item and the non-negotiable payment amount may be transmitted to various repair service providers. The terms of the work order may also require the repair service provider to provide the insurance company feedback identifying the actual cost to repair the damage to the item. The repair service provider that agrees to the terms of the work order may then repair (e.g., replace or restore) the damaged item for the claimant and provide feedback to the insurance company that indicates the actual repair cost. The insurance company may update the pool of actual repair cost data based on the feedback received. For example, the pool of repair cost data may be update to identify the difference between the repair cost amount initially generated by the repair cost generator and the actual repair cost indicated by the repair service provider. Accordingly a subsequent repair costs amount generated will be improved as a result of the updated actual repair cost data. Due to the actual repair cost data received as feedback, subsequent repair cost amounts generated will more likely be closer to their respective actual repair costs. The repair costs generated by the repair cost generator may continue to improve as more and more feedback is received from the repair service providers.

This iterative process thus corresponds to a feedback loop in which the input to the repair cost model—the actual repair cost data—is continuously updated based on feedback corresponding to the output of the repair cost model—the repair cost amount. Over time the difference between the repair cost generated by the repair cost generator and the actual repair cost should tend toward zero or at least toward a difference an insurance company may decide is negligible. As a result the need to generate repair cost estimates is advantageously eliminated. An insurance company may select a non-negotiable payment amount based on the repair cost generated. In some example implementations, the non-negotiable payment amount may equal the repair cost generated. In other example implementations, the non-negotiable payment amount may include a bonus (e.g., x % of the repair cost generated, a fixed bonus amount, etc.) in order to incentivize repair service providers to accept the non-negotiable payment amount, provide feedback regarding the actual repair cost, and so forth.

The non-negotiable payment amount and repair cost generated are distinguished from a repair estimate in that the repair service provider will not receive any additional remuneration for repairing the damaged item if the actual repair cost exceeds the non-negotiable payment amount or repair cost generated. Although the non-negotiable payment amounts may be lower than the actual repair costs initially, the non-negotiable payments amounts will adjust overtime to be closer to the actual cost of repair as more and more feedback is received from the repair service providers and used to improve the pool of actual repair cost data utilized by the repair cost model when generating repair cost amounts. Furthermore any initial profit losses may be offset by, e.g., the non-negotiable payment amounts paid to the repair service providers that exceed the actual costs to repair damaged items, the monetary incentives offered for accepting the non-negotiable payment amount and participate in the feedback process as well as savings resulting from avoiding the costs associated with communicating and renegotiating revised repair estimates. Furthermore insurance companies may afford repair service providers a preferred status by agreeing to participate in the feedback process, and the repair service providers may experience an increased volume of business as a result. Moreover repair service providers may cultivate more customer loyalty via a convenient and hassle-free repair process that advantageously avoids the possibility of higher bills after the repair is complete. Additional advantages will be appreciated with the benefit of the additional disclosures described in further detail below.

In accordance with various aspects of the disclosure, methods, computer-readable media, and apparatuses are disclosed in which insurance claims may be settled through an enhanced automated process. In certain aspects, an enhanced claims processing server manages the claims processing procedure from an initial notice of loss to transmittal of a work order to a repair service provider that repairs a damaged item.

The automated process may utilize various hardware components (e.g., processors, communication servers, memory devices, sensors, etc.) and related computer algorithms to examine an insured item after a claim has been filed for that item and to generate a work order that includes information describing the damage to the item and a non-negotiable payment for the repair service provider that repairs the damaged item.

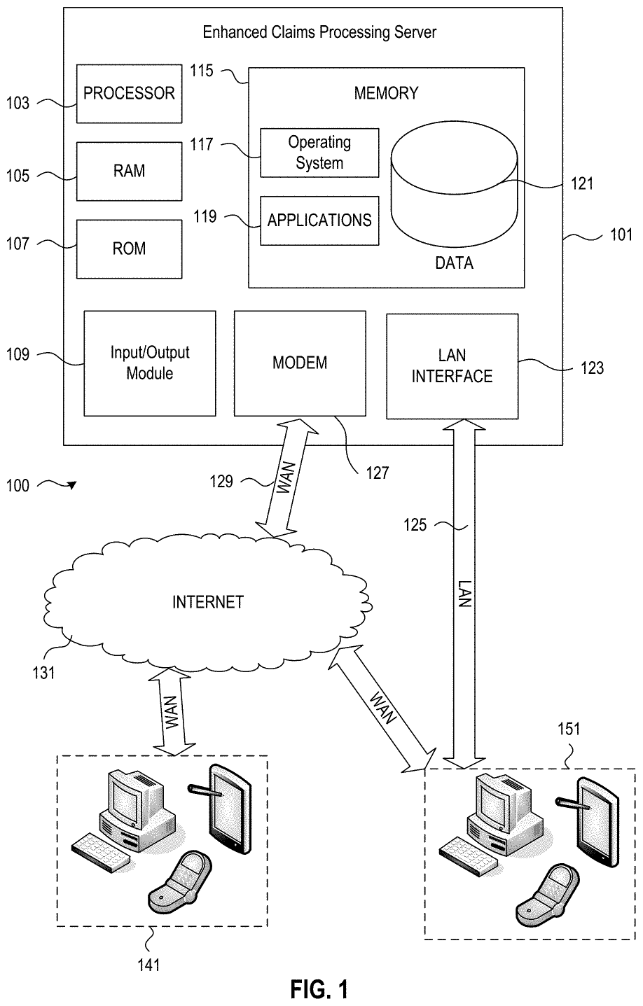

FIG. 1 illustrates a block diagram of an enhanced claims processing server 101 in communication system 100 that may be used according to an illustrative embodiment of the disclosure. Enhanced claims processing server 101 may have a processor 103 for controlling overall operation of the enhanced claims processing server 101 and its associated components, including RAM 105, ROM 107, input/output module 109, and memory 115.

Input/output module 109 may include a microphone, keypad, touch screen, and/or stylus through which a user of enhanced claims processing server 101 may provide input, and may also include one or more of a speaker for providing audio output and a video display device for providing textual, audiovisual and/or graphical output. Software may be stored within memory 115 to provide instructions to processor 103 for enabling enhanced claims processing server 101 to perform various functions. For example, memory 115 may store software used by the enhanced claims processing server 101, such as an operating system 117, application programs 119, and an associated database 121. Processor 103 and its associated components may allow the enhanced claims processing server 101 to run a series of computer-readable instructions to generate a repair cost amount for repairing the damage to the damaged item. In addition, processor 103 may determine an approved list of vendors for repairing the damaged item. Processor 103 may also schedule and accept appointments with vendors that may aid in repairing the damaged item.

The enhanced claims processing server 101 may operate in a networked environment supporting connections to one or more remote computers, such as terminals 141 and 151. The terminals 141 and 151 may be personal computers or servers that include many or all of the elements described above relative to the enhanced claims processing server 101. Also, terminal 141 and/or 151 may be sensors such as cameras and other detectors that allow damage related to an insured item for which a claim has been filed to be assessed. The network connections depicted in FIG. 1 include a local area network (LAN) 125 and a wide area network (WAN) 129, but may also include other networks. When used in a LAN networking environment, the enhanced claims processing server 101 is connected to the LAN 125 through a network interface or adapter 123. When used in a WAN networking environment, the enhanced claims processing server 101 may include a modem 127 or other means for establishing communications over the WAN 129, such as the Internet 131. It will be appreciated that the network connections shown are illustrative and other means of establishing a communications link between the computers may be used. Protocols such as TCP/IP, Ethernet, FTP, HTTP and the like may be selectively employed for network communications.

Additionally, one or more application programs 119 used by the enhanced claims processing server 101 according to an illustrative embodiment of the disclosure may include computer executable instructions for invoking functionality related to processing an insurance claim quickly and accurately (e.g., seconds or minutes), generating a repair cost amount for repairing damage to an item, creating work orders, transmitting work orders to repair service providers, receiving feedback from repair service providers, and updating a pool of actual repair cost data based on the feedback received. In one embodiment, aspects of the claim processing procedure discussed herein may occur in ten minutes or less.

Enhanced claims processing server 101 and/or terminals 141 or 151 may also be mobile and/or portable terminals (e.g., mobile cellular telephones, tablet computing devices, etc.) including various other components, such as a battery, speaker, and antennas (not shown). In this regard, enhanced claims processing server 101 may be a handheld or otherwise portable device that may be used to scan and process an insured item from all relevant angles.

The enhanced claims processing server 101 is thus a special-purpose computing device programmed with instructions that, when executed, perform functions associated with receiving damage information from claimants, generating repair cost amounts, creating work orders, receiving feedback from repair service providers. Although only a single enhanced claims processing server 101 is shown in FIG. 1, other example implementations may include multiple special-purpose computing devices that are interconnected with one another and programmed with instructions to respectively perform the functionality identified above. Such special-purpose computing devices may be, for example, application servers programmed to perform those particular functions.

The disclosure may be described in the context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including non-transitory memory storage devices, such as a hard disk, random access memory (RAM), and read only memory (ROM).

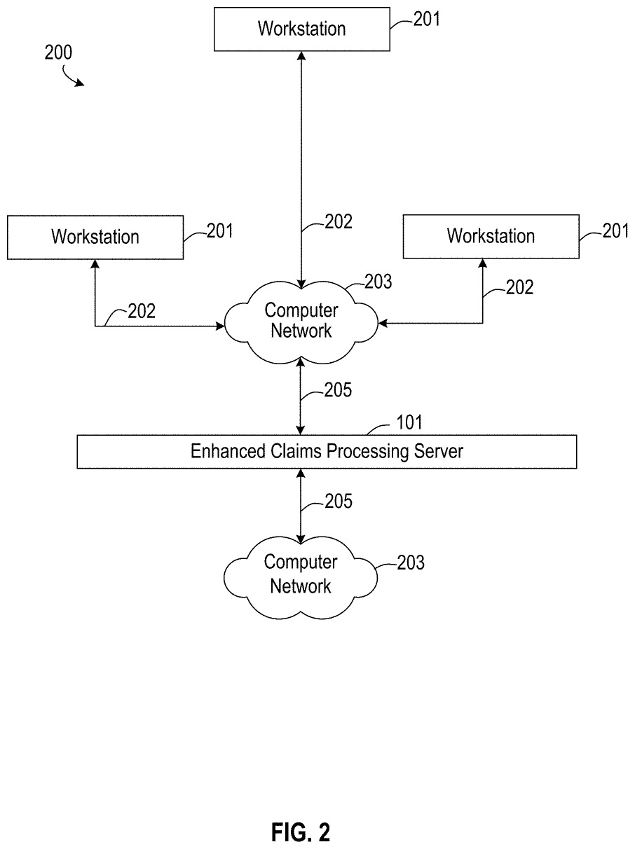

Referring to FIG. 2, a system 200 for implementing methods according to the present disclosure is shown. As illustrated, system 200 may include one or more workstations/servers 201. Workstations 201 may be local or remote, and are connected by one or more communications links 202 to computer network 203 that is linked via communications links 205 to enhanced claims settlement server 101. In certain embodiments, workstations 201 may run different algorithms used by enhanced claims processing server 101 for processing a claim submitted by a claimant, or, in other embodiments, workstations 201 may be different types of sensors that provide information to enhanced claims processing server 101 for assessing damage to an insured item for which a claim has been filed. In system 200, enhanced claims processing server 101 may be any suitable server, processor, computer, or data processing device, or combination of the same specially configured to carry out aspects of the disclosure.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and enhanced claims processing server 101, such as network links, dial-up links, wireless links, hard-wired links, etc.

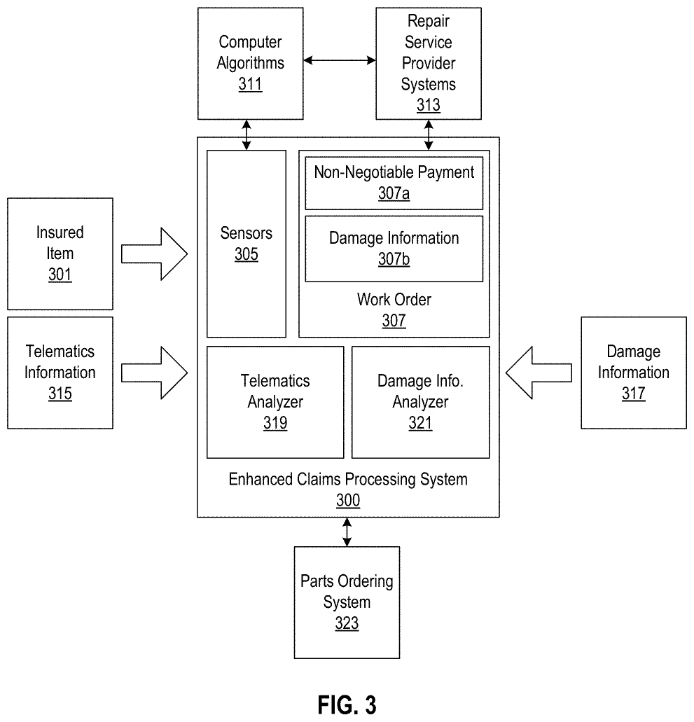

FIG. 3 is a block diagram of a workflow for using an enhanced claims processing server in accordance with at least one aspect of the present disclosure. An enhanced claims processing system 300 may include an enhanced claims processing server (such as enhanced claims processing server 101). The enhanced claims processing server 300 may carry out claims processing upon receipt of a first notification of loss (FNOL) associated with an insured item 301. The notification may be an automated notification of an accident from a telematics device, smart phone, and/or other device to enhanced claims processing system 300. In certain embodiments, if the accident is associated with a vehicle (e.g., car, truck, boat, etc.) the telematics device and/or smart phone may include an impact sensor that automatically transmits a notification of the accident involving the vehicle to enhanced claims processing system 300 when certain impact parameters are detected. Additional information such as speed, braking or acceleration for the time period immediately preceding and immediately subsequent to the accident as well as vehicle identifying information or insured information also may be transmitted by the telematics device and/or smart phone to the enhanced claims processing system 300. The vehicle identifying information may include license plate number, vehicle identification number, and/or vehicle make/model.

In other embodiments, claim processing may be initiated by the swipe of an insurance card or card including identification information (such as a credit card) through a sensor or card reader 305 of enhanced claims processing system 300. The insurance card or other card including identification information may include information related to the identity of the claimant (e.g., name, date of birth, terms of active insurance policies, etc.). In other embodiments, the claim processing procedure may be initiated by driving to a predetermined location associated with claims processing system 300 and having a license plate and/or vehicle identification number (VIN) read by a processor (such as processor 103), e.g., when the insured item 301 is a vehicle.

In certain aspects, the claim processing procedure may use one or more sensors 305 that are a part of or in communication with enhanced claims processing system 300 to assess damage associated with insured item 301. The sensors 305 may function simultaneously or sequentially (e.g., insured item 301 may be moved from one sensor station to another) to gather data about damage related to item 301.

The sensors 305 that are a part of enhanced claims processing system 300 may include various types of cameras (e.g., movable cameras, etc.) for taking optical digital images and/or other computing/mechanical devices (such as device 201) that may make laser and/or tactile measurements (e.g., for understanding the depth of damage to insured item 301). The sensors 305 may also measure the interaction of pressure (e.g., sound) waves or X-rays on the insured item 301 to analyze damage to the insured item. In yet other embodiments, various types of imaging technologies may be used to analyze the insured item 301. For instance, magnetic resonance imaging (MRI), infrared imaging, 3D imaging technologies (e.g., holographic imaging, etc.), and/or various types of tomography may be used to image insured item 301. The sensors 305 may also sense fluids such as transmission fluids, brake fluids, engine oil, etc. leaking from insured item 301. In other embodiments, sensors 305 may sense various aspects of tires that are a part of insured item 301 (e.g., when insured item 301 is a vehicle). For instance, sensors 305 may indicate that a frame associated with a body or a rim associated with a tire of insured item 301 is bent. Using sensors 305, server 101 may create a digital map showing the damage to insured item 301.

When the insured item 301 is a vehicle, a sensor 305 of the enhanced claims processing system 300 may also dock with an on-board diagnostic (OBD) or OBD-II system that may be a part of the vehicle's electronics system. The information recorded by the OBD and/or OBD-II system may include coolant temperature, engine RPM, vehicle speed, timing advance, throttle position, and the oxygen sensor, among other things. The OBD/OBD-II system or other system may also be used by enhanced claims processing system 300 to check the mileage in a vehicle for underwriting and/or pricing purposes. Some or all of this information may be used by enhanced claims processing system 300 to evaluate any damage to insured item 301.

In addition to gathering information through various sensors, the enhanced claims processing system 300 may also include a computer interface for a claimant to input information and/or answer questions (e.g., an automated questionnaire, etc.) around prior damage, liability, particulars of an accident, etc.

In certain aspects, enhanced claims processing system 300 may be configured to detect fraudulent claims. For instance, the automated questionnaire discussed above may also ask about an accident associated with the claim. The answers to the questions regarding the accident may be compared to the actual damage or sensor or OBDII readings associated with insured item 301. If enhanced claims processing system 300 determines that there are discrepancies between the actual damage or sensor or OBDII readings associated with insured item 301 as assessed by sensors 305 and a description of the damage provided in the answers to the automated questionnaire, then enhanced claims processing system 300 may notify a claims adjuster to intervene or take other action such as to terminate the claim. Also, if insured item 301 is a vehicle, enhanced claims processing system 300 may compare particulars about the vehicle (e.g., make, model, year of manufacture, VIN, etc.) to previously obtained vehicle information (e.g., stored in a memory associated with the enhanced claims processing system 300 and/or on file with an entity managing the system) for detecting fraud. Further, if after further analysis, the number of false positives for detecting fraud is beyond a predetermined threshold, the algorithm and/or questions used to detect fraud may be adjusted accordingly.

As another example, enhanced claims processing system 300 may be able to determine the speed of the insured item 301 (e.g., a vehicle) when an accident occurs. The speed determined by enhanced claims processing system 300 may be compared with the speed indicated by a claimant in the questionnaire. Finally, the enhanced claims processing system 300 may also be able to determine the number of people and the positions of each individual in the insured item 301 (e.g., a vehicle) when an accident occurs. This information may also be compared with the corresponding descriptions indicated by a claimant in the questionnaire.

In other aspects, enhanced claims processing system 300 may be able to interface with other databases/systems. For instance, enhanced claims processing system 300 may interface with meteorological databases to retrieve the weather conditions at the time of an accident associated with insured item 301. Enhanced claims processing system 300 may also interface with law enforcement databases to retrieve police reports of an accident associated with insured item 301 or with medical records or other databases related to people involved in an accident associated with the insured item 301.

In some implementations, a claims adjuster may view the insured item 301 through a video feed and enhanced claims processing system 300 may manipulate sensors 305 (e.g., cameras, etc.) to capture a desired view. For instance, the enhanced claims processing system 300 may allow the claims adjuster to communicate via an electronic interface that instructs the system to move sensors 305 to a given angle. Alternatively or in addition, insured item 301 may be directly manipulated by sensors 305 (e.g., mechanical arms, etc.) to allow the claims adjuster to examine a desired view of the insured item 301. For instance, the claims adjuster may instruct the enhanced claims processing system 300 to move robotic arms or lifts that are able to position the insured item 301 allowing the claims adjuster to view a desired portion of the insured item.

As mentioned above, enhanced claims processing system 300 may generate holograms (e.g., based on magnetic resonance imaging (MRI) or other techniques using predictive computer-aided design (CAD)-type technologies, etc.) for allowing claims adjusters and other individuals to view the insured item 301. The holograms may represent three-dimensional images of insured item 301 and may allow individuals to view the exterior of insured item 301 as well as features internal to insured item 301. For instance, a hologram may allow the different components comprising a vehicle's engine to be viewed and analyzed in ways that would not be feasible with traditional imaging modalities.

In some aspects, computer algorithms 311 which may be used in determining damage may be based on specifications and/or tolerances data related to a manufacturer of insured item 301. The computer algorithms 311, which may be stored in a memory (such as memory 115) of the enhanced claims processing system 300, may also direct the enhanced claims processing system to automatically delete any photos non-relevant to damage of/data related to insured item 301 based on a comparison of the photos/data to manufacturer specifications/tolerances.

Once the insured item 301 has been adequately analyzed by sensors 305, enhanced claims processing system 300 may then generate a work order 307. In certain aspects, enhanced claims processing system 300 may automatically generate the work order 307. The work order 307 may include a non-negotiable payment 307a for repairing the damage to insured item 301 and damage information 307b which may include a description of the damage and a list of parts and part vendors for repairing the insured item 301. In addition to or alternatively, if the owner of insured item 301 is to be provided compensation for loss/damage to insured item 301, enhanced claims settlement server 101 may generate a payment card (e.g., a prepayment card) that may be used by the owner of insured item 301. The work order 307 may also be provided to the claimant as a record of the damage detected and the cost to repair the damage. The work order may also include a listing of the area, components, or parts of the item that need to be repaired or replaced.

In another aspect of the disclosure, the work order 307 may stipulate various terms of the settlement, including an agreement that the repair service provider will only receive the non-negotiable payment amount as remuneration for repairing the damage. The work order 307 may also stipulate that the repair service provider will provide feedback indicating the actual cost to repair the damage to the insured item 301. The work order may also include discounts provided to the claimant for errors on the part of enhanced claims processing system 300. For instance, the work order 307 may provide for a predetermined discount (e.g., 10% off) for any out-of-pocket expense of the claimant associated with repairing the insured item 301 if the enhanced claims processing system 300 does not detect all of the damage to the insured item (e.g., hidden damage). Moreover, once the work order 307 has been generated by enhanced claims processing system 300, the information in the work order may be transmitted to a repair service provider system as well as to a claimant computing device.

Once the data/photos related to insured item 301 are generated by various sensors 305 and/or once the claim settlement file 307 is generated by enhanced claims settlement server 101, the enhanced claims processing system 300 may provide the work order 307 and/or data/photos to a repair service provider system 313. The enhanced claims processing system 300 may also initiate payment of the non-negotiable payment 307a to the repair service provider that has accepted the terms of the work order 307.

In other aspects, enhanced claims processing system 300 may automatically apply a deductible amount to the work order 307. In addition, enhanced claims processing system 300 may also automatically generate cross-sell material (e.g., other products/services offered by the entity managing enhanced claims processing system 300) for review while a claimant waits for a work order 307 to be generated. For instance, if the entity managing enhanced claims processing system 300 is an insurance company, the enhanced claims processing system 300 may generate information about other types of insurance products offered by the insurance company while the claimant is waiting for claim processing. In certain aspects, aspects of the claims processing procedure may be highly automated and, therefore, completed in a short amount of time (e.g., seconds, minutes, etc.).

As noted above, a telematics device may provide telematics information 315 to the enhanced claims processing system 300. As described in further detail below, a damage collection device may similarly provide damage information 317 to the enhanced claims processing system 300. The enhanced claims processing system 300, in this example, includes a telematics analyzer 319 configured to analyze the telematics information 315 received as well as a damage information analyzer 321 configured to analyze the damage information 317 received. Analysis of the telematics information 315 may also constitute a first notice of loss where the telematics analyzer 319 determines that the insured item 301 has been damaged based on the telematics information received. Analysis of the telematics information 315 and the damage information 317 may also indicate one or more parts of the insured item 301 that will need to be obtained in order to repair the insured item. The telematics analyzer 319 and the damage information analyzer may be configured to generate, independently of each other or in conjunction with each other, a list of parts needed to repair the insured item 301.

The enhanced claims processing system may query one or more repair service provider systems 313 to determine whether a repair service provider has the parts needed to repair the insured item 301 (or at least ready access to the parts needed to repair the insured item) and has the capacity to promptly repair the insured item within a reasonable timeframe (e.g., around the average amount of time needed to conduct repairs of the type needed). The enhanced claims processing system 300 may also be in signal communication with a parts ordering system 323 and transmit a parts order to the parts ordering system. The parts order may include the list of parts identified by the telematics analyzer 319 or the damage information analyzer 321. If a repair service provider has been selected to repair the insured item 301, then the enhanced claims processing system 300 may identify that repair service provider as the recipient for the delivery of the parts order. If a repair service provider has not yet been selected, then the enhanced claims processing system 300 may identify a local distribution center as the recipient for the delivery of the parts order. The local distribution center may be one that is located in a geographic region within which the claimant will have the insured item 301 repaired. In either case, the enhanced claims processing system 300 reduces repair wait times by obtaining or requesting the parts needed to repair the damaged item shortly after receipt of the first notice of loss. In this way, the parts may have already been delivered to or may already be in transit to the repair service provider when the claimant delivers the insured item 301 to the repair service provider for repair.

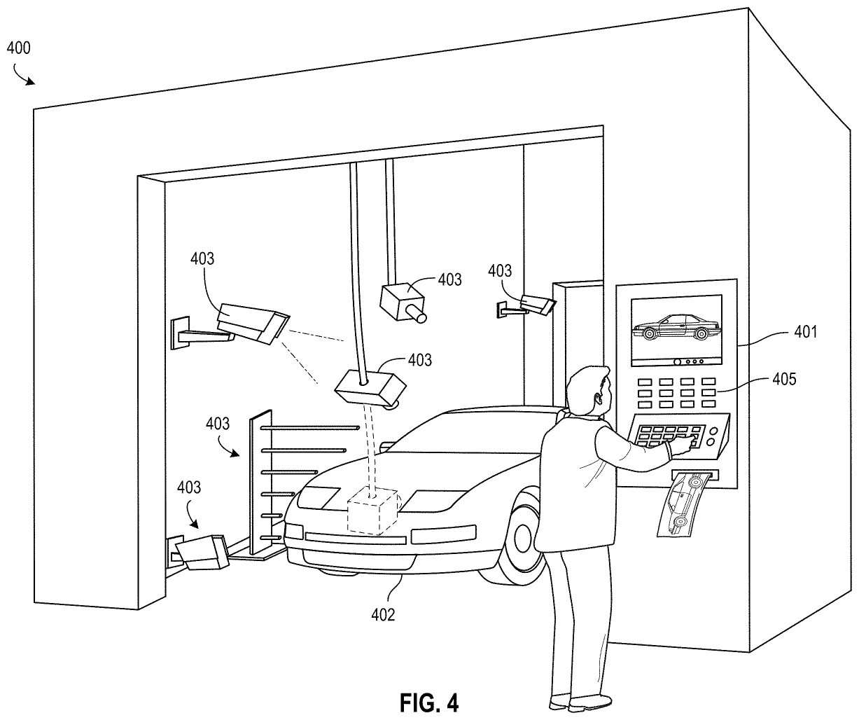

FIG. 4 illustrates an enhanced claims processing apparatus 400 employing an enhanced claims processing server 401 in accordance with various aspects of the present disclosure. The enhanced claims processing server 401 may be the same as or at least similar to the enhanced claims processing server 101 described above with reference to FIG. 1. Like the enhanced claims processing server 101, the enhanced claims processing server 401 is a special-purpose computing device programmed with instructions to perform functionality described herein. The enhanced claims processing server 401, in this example, may be used when the insured item is a vehicle 402. In FIG. 4, an owner of vehicle 402 may file a claim for damage to vehicle 402. The owner may notify enhanced claims processing server 401 through any of the various modalities mentioned above, including automatic notification via a telematics device, through manual notification, and/or by simply driving to a predetermined location associated with enhanced claims processing server 401. Vehicle 402 may be analyzed by various sensors 403 (e.g., cameras, tactile sensors, ultrasonic sensors, electromagnetic sensors, etc.), which may be a part of enhanced claims processing apparatus 400, to determine damage caused to vehicle 402 so that a work order (such as work order 307) may be generated by enhanced claims processing server 401. Enhanced claims processing server 401 may also include a user interface 405 through which a user may perform various activities. For instance, a user may swipe an insurance card associated with vehicle 402 through user interface 405. In addition, a user may, through user interface 405, view/print photos, data, and other information generated by enhanced claims processing server 101.

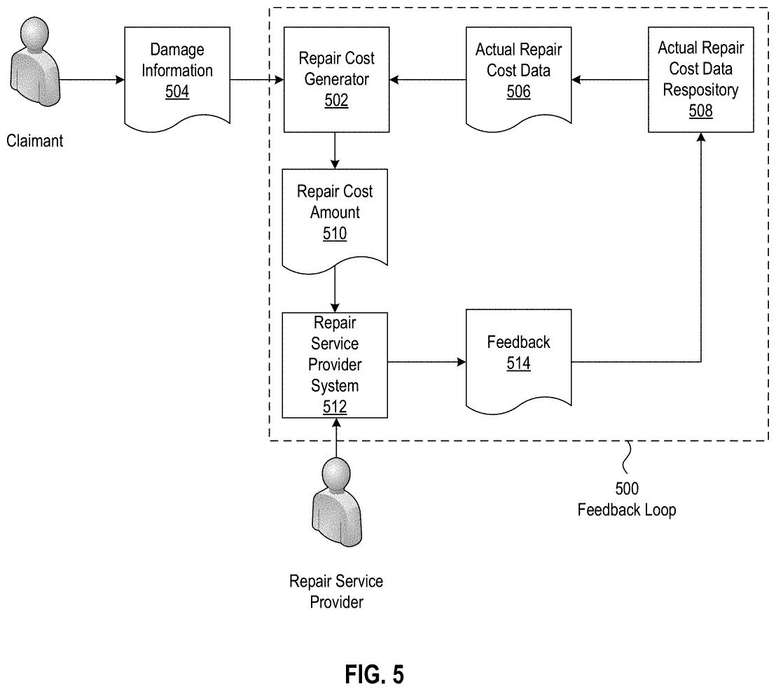

Referring now to FIG. 5, a block diagram of the feedback loop 500 provided by the enhanced claims processing system in accordance with at least one aspect of the present disclosure. As seen in FIG. 5, a repair cost generator 502 may receive damage information 504 from a claimant and actual repair cost data 506 from an actual repair cost data repository 508. As described above, the damage information 502 may describe or otherwise indicate the damage to an item such as a vehicle. The damage information 502 may identify the item type such as the make, model, and year where the item is a vehicle for example. The damage information 502 may also identify one or more areas or portions of the item that has been damaged. Where the item is a vehicle, for example, the damage information 502 may identify the location of the damage on the vehicle (e.g., front, rear, left side, right side, roof, etc.), or particular components of the vehicle that have been damaged (e.g., front/rear windshield, side windows, headlights, trunk, wheels, rims, etc.). The damage information 502, may include, for instance, readings from various sensors that have assessed the vehicle, images of the vehicle that depict the damage, recorded data retrieved from devices installed at the vehicle that operation or use of the item, answers from the claimant in response to questions posed regarding the circumstances in which the damage occurred, and other types of information related to damage of the item. The actual repair cost data 506 retrieved from the actual repair cost data store 508 may depend on the damage information received from the claimant. For example, the actual repair cost data 506 retrieved may be associated with the type of item that was damaged and correspond to the area or components indicated as damaged in the damage information 502.

Based on the damage information 504 received and the actual repair cost data 506 retrieved, the repair cost generator 502 may generate a repair cost amount 510. As described above, the repair cost amount 510 may be used to select a non-negotiable payment amount for repairing the damage to the item. The repair cost amount 510 may then be provided to a repair service provider system 512, e.g., as part of a non-negotiable payment included in a work order. A repair service provider that has accepted the terms of the work order may repair the damaged item and receive the non-negotiable payment as remuneration for performing the repair. The repair service provider may then use the repair service provider system 512 to generate feedback 514 regarding the repair of the item. The feedback 514 may identify the actual cost to repair the item. The feedback 514 may also indicate the area or components of the item and respective actual costs to repair each area or component. The feedback 514 may also include a total actual repair cost that is the sum of the actual repair costs for each area or component. The feedback 514 may also identify damaged areas or components not identified in the initial work order as well as the cost to repair those unidentified damaged areas or components. The cost of repairing unidentified damaged areas or components may be included in the total actual repair cost identified in the feedback 514. The feedback 514 from the repair service provider system 512 may be used to update the actual repair cost data repository 508. Upon subsequent receipt of similar damage information, the actual repair cost data 506 retrieved will have taken into account the feedback 514 previously received. As a result the repair cost amount 510 generated by the repair cost generator 502 is more likely to be closer to the actual repair cost. This feedback loop 500 may repeat many times over with feedback received from multiple repair service providers. As noted above, the more feedback received the close repair cost amounts get to the actual repair costs reported by the repair service providers in their feedback.

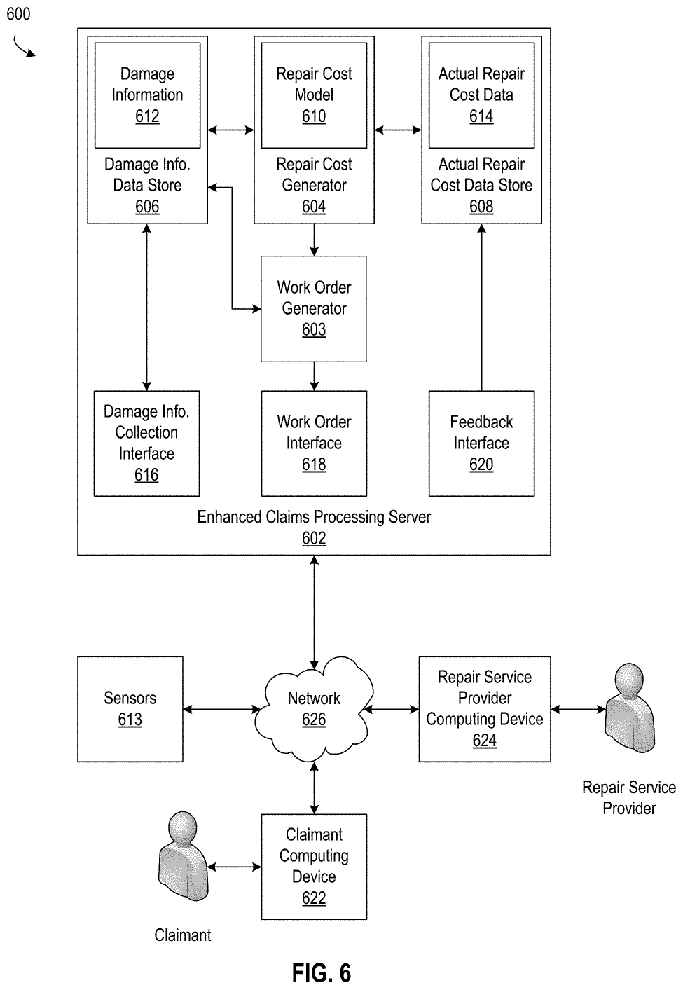

Referring now to FIG. 6, a block diagram of an example of an implementation of an enhanced claims processing system 600 is shown. The enhanced claims processing system 600 includes an enhanced claims processing server 602. The enhanced claims processing server 602 may include at least some of the same components and be configured to carry out at least some of the same functionality as the enhanced claims processing servers 101 and 401 described above with reference to FIG. 1 and FIG. 4 respectively. Like the enhanced claims processing servers 101 and 401, the enhanced claims processing server 602 is a special-purpose computing device programmed with instructions to perform functionality described herein. The enhanced claims processing server 602, in this example, includes a work order generator 603 in signal communication with a repair cost generator 604. The work order generator 603 and the repair cost generator 604 are each in signal communication with a damage information data store 606. The repair cost generator 604 is also in signal communication with an actual repair cost data store 608.

The work order generator 603, in this example, is configured to generate the work orders that describe the damage to an item and select a non-negotiable payment amount based on the repair cost generated by the repair cost generator as described above. The work order generator 603 may also be configured to select the non-negotiable payment amount based on the repair cost generated by the repair cost generator. The work order generator 603 may, for example, select the bonus to be applied to the repair cost generated in order to incentivize a repair service provider to accept the non-negotiable payment amount. As noted above, the non-negotiable payment amount may be equal to, in some implementations, the repair cost plus x % of the repair cost. The work order generator 603 may also be configured to select a set of repair service providers to initially transmit the work order to. As also noted above, repair service providers that agree to participate in the feedback process may receive a preferred status that allows them to receive work order offers before other repair service providers. The work order generator 603 may thus select a set of repair services providers based on a preferred status. The work order generator 603 may also select the set of repair service providers based on the consistency or timeliness with which the repair service providers provide feedback. The work order generator 603 may, for example, select the repair service providers that most consistently and quickly provide feedback as the first set of service providers the work order is transmitted to. In this way, an insurance company that provides the enhanced claims processing system may incentivize repair service providers to participate in the feedback process and accept the non-negotiable payment amounts.

The repair cost generator 604, in this example, includes a repair cost model 610, which may be the same as or at least similar to the repair cost model 502 described above with reference to FIG. 5. The damage information data store 606 may store the damage information 612 received from claimants or sensors 613. The sensors 613 may be the same as or at least similar to the sensors 305 and 403 described above with reference to FIG. 3 and FIG. 4 respectively. The damage information 612 stored at the damage information data store 606 may include the same types of information as the damage information 504 described with reference to FIG. 5. The actual repair cost data store 608 may store actual repair cost data 614 which may similarly include the same types of information as the actual repair cost data 506 described above with reference to FIG. 5. The actual repair cost data may also include data identifying different types of items (e.g., a make, model, and year of a vehicle) as well as the actual costs to repair or replace various areas of those items (e.g., the front, rear, or side areas of the vehicle) or various components of those items (e.g., bumper, headlight, windshield, side mirror, door panel, etc. of a vehicle). The actual repair cost data 614 may also include the labor costs associated with repairing a damaged item. The repair cost generator 604 may retrieve the damage information 612 and the actual repair cost data 614 from the respective data stores 606 and 608 and configure the repair cost model 610 with the damage information and actual repair cost data retrieved. As noted above the repair cost generator may retrieve the portions of the actual repair cost data 614 that correspond to the damage information 612 received from the claimant. The repair cost generator 604 may configure the repair cost model 610 in this fashion for each repair cost generated in response to receipt of an FNOL from a claimant regarding damage to an item. The actual repair cost data 614 may also be utilized to adjust insurance rates for vehicles based on the observed costs associated with fixing those vehicles. If the actual repair cost data indicates that it is relatively less expensive to fix one type of vehicle, then the rates to insure that vehicle may be adjusted lower as a result. Similarly if the actual repair cost data indicates that it is relatively more expensive to fix another type of vehicle, then the rates to insure that other vehicle may be adjusted higher as a result.

In some example implementations, a repair cost generator may additionally or alternatively utilize telematics data received from a telematics device to generate the repair cost amount. In these other example implementations, the repair cost generator may configure a repair cost model with telematics data received from a telematics device associated with the damaged item and telematics data associated with previously settled claims. The repair cost model may thus generate a repair cost for repairing a damaged item based on comparisons to previously settled claims associated with similar telematics data. For example, if previously settled claims associated with a set of telematics data resulted in an average payment of $x to a claimant, then the repair cost generator may also generate a repair cost of $x if a new claim is associated with a similar set of telematics data. A repair cost generator may also, in some example, implementations configure the repair cost model and generate a repair cost based on a combination of damage information and telematics information received. In some example implementations, the repair cost model may comprise a lookup table.

The enhanced claim processing server 602, in this example, also includes various interfaces to facilitate receiving damage information from a claimant, providing work orders to repair service providers, and receiving feedback from repair service providers. In particular, the enhanced claim processing server 602, in this example, includes a damage information collection interface 616, a work order interface 618, and a feedback interface 620. The enhanced claim processing server 602 may use these interfaces to communicate with a claimant computing device 622 and a repair service provider computing device 624 through a network 626 such as, e.g., the Internet. The interfaces may include, for example, web servers that provide web pages to the claimant computing device 622 and the repair service provider computing device 624. The interfaces may additionally or alternatively include mobile servers for communicating with the claimants and repair service providers via mobile applications installed at the claimant computing device 622 and the repair service provider computing device 624.

The enhanced claims processing server 602 may receive damage information 612 from a claimant via a damage information collection web page provided by the damage information collection interface 616. The damage collection web page may include input elements that enable the claimant to identify the item that was damaged and indicate the particular areas or components of the item where damage occurred. The damage information collection interface 616 may forward the damage information 612 received from the claimant to the damage information data store 606 for storage.

The enhanced claims processing server 602 may transmit work orders to the repair service providers via a work order web page provided by the work order interface 618. The work order generator 603, in this example, is in signal communication with the work order interface 618 and may provide the work order generated for transmission to the repair service provider, e.g., in a work order web page. The work order web page may identify the item that was damaged, a description of the damage to the item, the non-negotiable payment amount, and the terms of the work order. The enhanced claims processing server 602 may also receive acceptance or rejection of the terms of a work order through the work order web page. A claimant may also obtain a copy of the work order for the item via the work order web page. The copy of the work order may include information identifying the repair service provider that accepted the terms of the work order.

The enhanced claim processing server 602 may receive feedback from the repair service providers via a feedback web page provided by the feedback interface 620. The feedback web page may include input elements that allow the repair service provider to identify areas or components of the item that were repaired and the actual cost to repair those items as described above. The feedback interface 620 may forward the feedback received from the repair service providers to the actual repair cost data store 608 for storage as actual repair cost data 614.

In some example implementations, the insurance company may limit the opportunity to receive non-negotiable payments to “in-network” repair service providers. If the “in-network” service providers do not include a repair service provider the claimant prefers, an insurance company may provide the claimant with incentives for selecting an “in-network” repair service provider. Such incentives may include, e.g., a reduced deductible on an insurance policy, no deductible on an insurance policy, reduced insurance premiums, expedited repair of the damaged item, a guarantee of the quality of the repair, and the like.

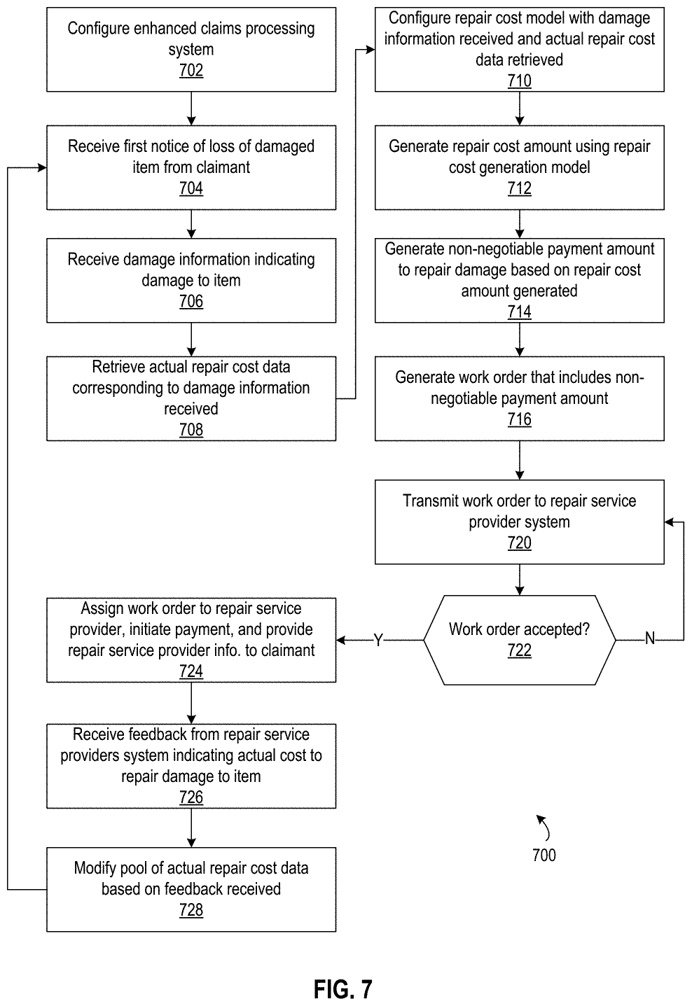

Referring now to FIG. 7, a flowchart 700 of example method steps for using an enhanced claims processing system with a feedback loop in accordance with at least one aspect of the present disclosure is shown. To process claims for damage to items, an enhanced claims processing system may be configured (block 702). Configuring the enhanced claims processing system may include seeding an actual repair cost data store with an initial set of data indicating the actual repair costs to repair a damaged item. As noted above, the actual repair cost data may include data indicating historical costs for repairing areas of a damaged item, repairing individual components of a damaged item, or replacing individual components of a damaged item.

Having configured the enhanced claims processing server, a first notice of loss may be received from a claimant regarding damage to an item (block 704). The enhanced claims processing system may also receive from the claimant damage information that indicates the damage to the item (block 706). The damage information may be received with or subsequent to the FNOL. Having received the damage information, the enhanced claims processing system may retrieve actual repair cost data that corresponds to the damage information received (block 708). The enhanced claims processing system may then configure a repair cost model using the damage information received and the actual repair cost data retrieved (block 710). The enhanced claims processing system may then utilize the repair cost model to generate a repair cost amount (block 712) and generate a non-negotiable payment amount for repairing the damaged item based on the repair cost amount (block 714). As noted above, the non-negotiable payment amount may equal the repair cost amount or include one or more bonuses to serve as incentives for accepting the terms of a work order with the non-negotiable payment.

The enhanced claims processing system may generate a work order that includes the non-negotiable payment amount (block 716) as described above. The enhanced claims processing system may then transmit the work order to one or more repair service provider systems (block 720) respectively maintained by one or more repair service providers. If one of the repair service providers accepts the terms of the work order (block 722:Y), then the enhanced claims processing system may assign the work order to that repair service provider, initiate payment of the non-negotiable payment amount to the repair service provider, and provide information associated with the repair service provider to the claimant (block 724), e.g., name, location, reservation time, and the like. The enhanced claims processing system may, in some example implementations, initiate payment of the non-negotiable payment amount to the repair service provider upon acceptance of the terms of the work order. In other implementations, the enhanced claims processing system may initiate payment of the non-negotiable payment amount upon receipt of the feedback from the repair service provider. In still other implementations, the enhanced claims processing server may initiate payment of a portion of the non-negotiable payment amount upon acceptance of the terms of the work order and initiate payment of the remaining portion of the non-negotiable payment amount upon receipt of the feedback from the repair service provider. If the work order is not accepted by a repair service provider (block 722:N), the enhanced claims processing system may transmit the work order to one or more additional repair service providers. In some example implementations, the enhanced claims processing server may transmit the work order to multiple repair service providers at once (e.g., multiple “in-network” service providers) in which case the work order is assigned to the first repair service provider that accepts the terms of the work order. In other example implementations, the enhanced claims processing server may transmit the work order to individual repair service providers in a sequential fashion whereby a subsequent repair service provider has the opportunity to accept the terms of the work order if a previous repair service provider rejects the terms of the work order. The sequence of repair service providers may be based on various criteria such as, e.g., customer rating, participation in the feedback process, location relative to the claimant, and so forth.

Having repaired the damaged item, the repair service provider may transmit feedback to the enhanced claims processing system indicating the actual cost to repair the item (block 726). As noted above the feedback may include a listing of the areas, components, or parts of the item that were repaired, individual costs to repair those portions of the item, and an overall cost to repair the item which may include a sum of the individual costs to repair the various portions of the item, labor costs, and so forth. The enhanced claims processing system may modify the pool of actual repair cost data based on the feedback received (block 728). Modifying the actual repair cost data based on the feedback may include adding new actual repair cost data to the pool of actual repair cost data as well as changing or removing existing actual repair data from the pool of actual repair cost data. As a result, the next time a FNOL is received regarding similar damage to a similar item, the repair cost amount generated by the repair cost model is more likely to be closer to the actual cost to repair the item ultimately reported by the repair service provider that repairs the item. With respect to vehicle repair, the number of vehicle repairs that occur daily represent an extensive source of potential repair data that may be harnessed to improve the generation of repair cost amounts. By minimizing the difference between the repair costs generated by the repair cost model and the actual repair costs reported by service providers, the need for estimating repair costs is therefore eliminated. By eliminating repair estimates, an insurance company may streamline the process or reporting damage to an item and having that item repaired. Although the present disclosure has been described in the context of automobile insurance and vehicle repair, the techniques described above may be suitably employed for other types of insurance and item repair including, for example, home insurance, boat insurance, and the like.

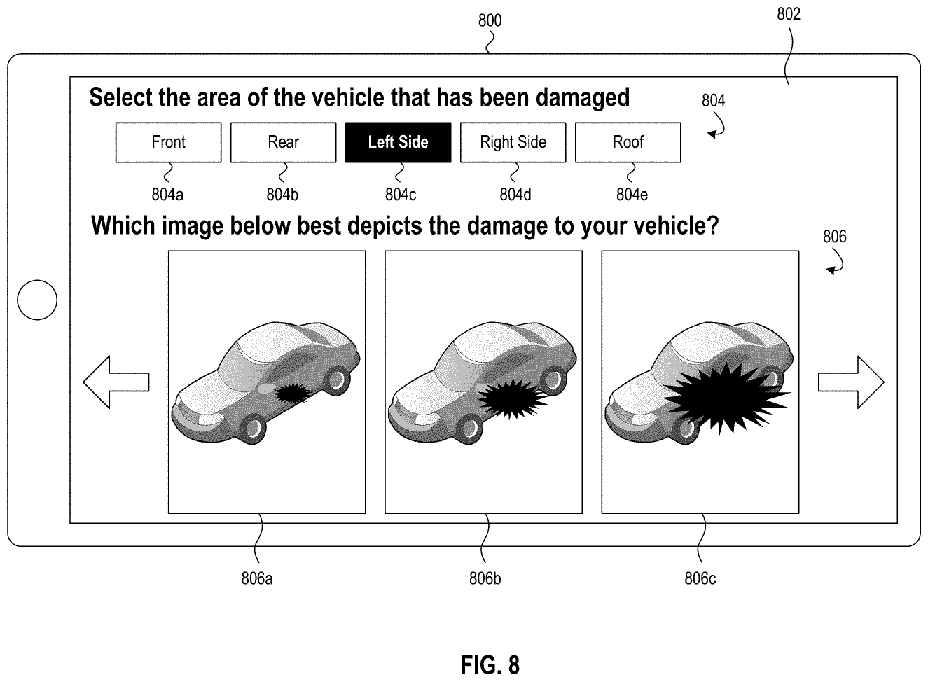

Referring now to FIGS. 8-10, approaches to collecting damage information from a claimant are described. Commonly-owned U.S. patent application Ser. No. 13/933,576 entitled “Feedback Loop in Mobile Damage Assessment and Claims Processing” and filed on Jul. 2, 2013 describes an approach to claims processing that involves collecting images of a damaged item from a claimant and using the images captured by the claimant to assess the damage to the item. In some circumstances, however, the computing devices available to a claimant may not be equipped or configured to capture images of the damaged item. In these circumstances, the approach below may be employed to collect damage information from the claimant without requiring the claimant to capture images of the damaged item.

As described in further detail below, an enhanced claims processing system may collect damage information from the user via images selected by the user that best represent the damage to the item. Referring to FIG. 8, an example of an implementation of a damage collection device 800 is shown at which a damage information collector 802 resides. The damage information collector 802, in this example, is configured to collect damage information regarding damage to a vehicle. As seen in FIG. 8, the damage information collector 802 presents a set of input elements 804 (collectively) the user may use to identify portions of the vehicle that has been damaged. The damage information collector 802, in this example, includes input elements for selecting areas of the vehicle that have been damaged, e.g., a “front” input element 804a, a “rear” input element 804b, a “left side” input element 804c, a “right side” element 804d, and a “roof” element 804e.

The set of elements 804 illustrated in FIG. 8 are shown by way of example only. Other implementations of the damage information collector may include additional or alternative input elements. In some implementations, for example, the set of input elements may include more granular areas of a vehicle, e.g., respective input elements for the “front,” “right,” “left,” “rear,” “top,” “front right side,” “rear right side,” “front left side,” “rear left side,” “front right,” “front left,” “rear right,” “rear left,” “window area,” “windshield area,” “panel area,” “door area,” “wheel area,” and other areas of the vehicle. In addition, some example implementations may include input elements for selecting individual components of the vehicle have been damaged such as, e.g., “front windshield,” “rear windshield,” “front right headlight,” “front left headlight,” “rear right brake light,” “rear left brake light,” “front windshield,” “rear windshield,” “front bumper,” “rear bumper,” “hood,” “trunk,” “roof,” “panel,” “front left door,” “front left window,” “rear left door,” “rear left window,” “front right door,” “front right window,” “rear right door,” “rear right window,” “left side mirror,” “right side mirror,” “front left tire,” “rear left tire,” “front right tire,” “rear right tire,” and other components of the vehicle. Other types of items may include additional and alternative areas and components that will be appreciated with the benefit of this disclosure. Areas of an item may include multiple components of the item, e.g., a “front right side” area of a vehicle may include the front bumper, hood, and front right headlight of the vehicle.

The set of input elements may also include input elements that allow the user to select the type of damage that occurred to the selected portion of the item, e.g., dent, puncture, fire, detachment, crack, shatter, etc. Having selected an input element to indicate the portion of the item that was damaged, the claimant may then select an input element to indicate the type of damage that occurred. The damage information collector 802 may allow the user to select multiple input elements to indicate the type of damage that occurred, e.g., if the damage to a portion of a vehicle includes both dents and punctures.

The damage information collector 802 may also present a series of images 806 (collectively) that depict increasing degrees of damage to the selected area or component of a reference item. Each image in the series of images 806 may depict relatively more damage than the image that preceded it. For reference, the first image in the series of images 806 may, for example, depict no damage to the area or component of the reference item. The claimant may then scroll through the series of images 806 to select which image best depicts the damage to the item associated with the insurance claim made. As shown by way of example in FIG. 8, the “left side” input element 804c has been selected, and the series of images 806 include images that depict increasing degrees of damage to the left side of a reference vehicle. In this example, image 806a depicts a relatively small amount of damage to the left side of the reference vehicle, image 806b depicts a relatively moderate amount of damage to the left side of the reference vehicle, and image 806c depicts a relatively large amount of damage to the left side of the reference vehicle. Other images in the series of images 806 may depict relatively more or less damage to the reference vehicle. In addition, the series of images may be selected such that they depict the type of damage indicated by the claimant via the selection of input elements corresponding to the type of damage that occurred. Some of the images presented to the claimant may depict the entirety of the reference item, and some of the images presented to the claimant may only depict portions of the reference item, e.g., close-up images on various areas or components of the reference item. The series of images may be a series of photos of the reference item, a series of graphical representations of the reference item, and combinations thereof.

In addition, the damaged item and the reference item may be of the same item type. As an example the reference item depicted in the series of images may have the same model number as the damaged item. Where the damaged item is a vehicle, for example, the reference item may depict a vehicle having the same make, model, and year as the damaged vehicle. In some example implementations, the damaged item and the reference item may be different—but similar—item types, e.g., items that are similar but having different model numbers. Where the damaged item is a vehicle, for example, the reference item may be a vehicle having a different year than the damaged vehicle. In some example implementations, an estimated cost to repair the damaged item may be determined even where the series of images depict an item of a different make or model, e.g., a different vehicle make, model, and year. Knowing the item type of the damaged item and the areas and components that were damaged may be sufficient to estimate a cost to repair the item even when the damage information is collected using depictions of a different type of reference item.

The claimant may select as many areas or components of the item as necessary to comprehensively indicate the damage to the item. The damage information collector 802 may identify the images selected by the user in the damage information transmitted to the enhanced claims processing system. As described in further detail below, the damage collection device 800 may be in signal communication with the enhanced claims processing server to transmit communications identifying the portions of the damages item selected by the claimant, receive communications that include the series of images corresponding to the damage portions selected, and transmit communications identifying the images selected by the claimant as best representing the damage to the item.

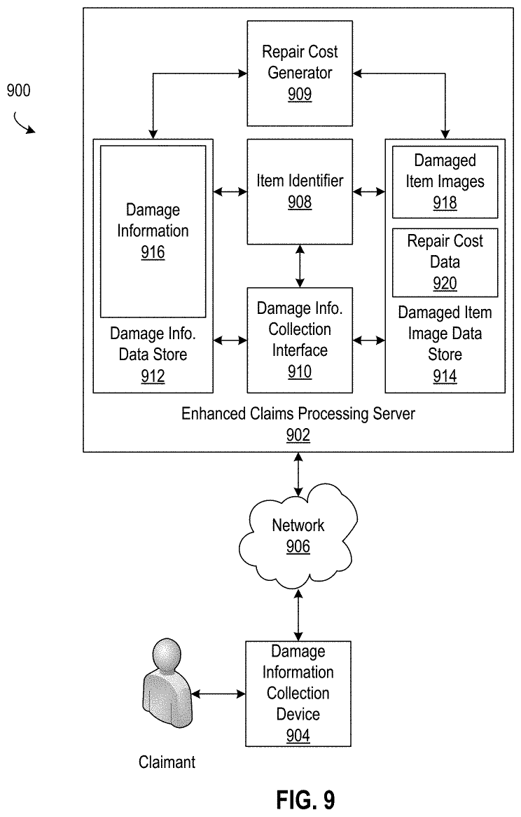

Referring now to FIG. 9, another example of an implementation of an enhanced claims processing system 900 in accordance with at least one aspect of the present disclosure is shown. The enhanced claims processing system 900 may be similar to the enhanced claims processing system 600 described above with reference to FIG. 6. The enhanced claims processing system 900 similarly includes an enhanced claims processing server 902 which may include at least some of the same components and be configured to carry out at least some of the same functionality as the enhanced claims processing servers 101, 401, and 602 described above with reference to FIG. 1, FIG. 4, and FIG. 6 respectively. The enhanced claims processing server 902, in this example, is in signal communication with a damage information collection device 904 via a network 906 such as the Internet. The damage information collection device 904 may be the same as or at least similar to the damage information collection device 800 described above with reference to FIG. 8. As described, a claimant may utilize the damage information collection device 904 to provide damage information that indicates the damage to a damaged item.

Like the enhanced claims processing servers 101, 401, and 602, the enhanced claims processing server 902 of FIG. 9 is also a special-purpose computing device programmed with instructions that, when executed, perform to collect damage information from the damage information collection device 904 and determine an generate a cost to repair a damaged item based on images selected as best depicting the damage that occurred to the item. Again, although only a single enhanced claims processing server 902 is shown in FIG. 9, other implementations may include multiple special-purpose computing device that are interconnected with one another and programmed with instructions to respectively perform the functionality identified above.

The enhanced claims processing server 902, in this example, includes an item identifier in signal communication with a damage information collection interface 910, both of which are also in signal communication with a damage information data store 912 and a damaged item image data store 914. The damaged item image data store 914 may store the damaged item images 918. In the context of damaged vehicles, for example, the damaged item images 918 may include images of damaged vehicles. The damaged item images 918 may include multiple images for the same type of vehicle whereby individual images of that vehicle depict varying degrees of damages to various areas or components of the vehicle, e.g., as described above with reference to FIG. 8.

The damage information collection interface 910 may be configured to exchange communications with the damage information collection device 904. The exchanged communications may identify the selections indicating the damaged portions of the item, deliver one or more of the damaged item images 918 for presentation to the claimant, and indicate the images selected by the claimant as best representing the damage to the item. In use, the damage collection interface 910 may receive a communication indicating a portion of the item the claimant has identified as damaged. The damage collection interface 910 may then retrieve a series of damaged item images from the set of damaged item images 918 (i.e., a subset of images) that correspond to the damaged portion identified and send those images to the damage information collection device 904. The damage information 916 received via the damage information collection interface 910 may thus include information indicating which damaged item images 918 were selected by the claimant as best representing the damage to the item. The damage information data store 912 may store the damage information 916 which may also be associated with a record of the FNOL provided by the claimant.

Metadata stored with or otherwise associated with the respective damaged item images 918 may describe the item itself as well as the type of damage depicted in the image. With respect to damaged vehicles, image metadata may include, e.g., the make, model, and year of the vehicle; the area or component of the vehicle that is damaged in the image; and the type of damage depicted in the image. The image metadata may thus correspond to the selectable input elements (e.g., input elements 804) presented to the claimant at a damage information collector (e.g., damage information collector 802) residing at the damage information collection device 904. The damaged item image data store 914 may also store repair cost data 920 that is respectively associated with one or more of the damaged item images 918. The enhanced claims processing server 902 may utilize the repair cost data 920 when generating a repair cost amount based on the damaged item images 918 selected by a claimant as best representing the damage to an item.

The item identifier 908, in this example, may be configured to automatically identify the type of item that was damaged and its corresponding characteristics. In some example implementations, the FNOL received from the claimant may include a customer number or unique identifier associated with the item such as, e.g., a vehicle identification number (VIN) of a vehicle. The item identifier 908 may perform a lookup in a customer database using the customer number to determine the items (e.g., vehicles) associated with the claimant. For example, an insurance customer database may store the VINs of the vehicles insured by an insurance policy associated with the customer. The item identifier 908 may thus retrieve the VIN of the vehicle associated with the claimant using the customer number provided by the claimant. If multiple items are associated with the claimant, the enhanced claims processing server may exchange communications to confirm which of the items was damaged. Having retrieved the unique identifier for the damaged item, the item identifier 908 may retrieve (e.g., from an item database) descriptive information for that item. In the context of vehicles, the descriptive information may include the make, model, and year of the vehicle. The descriptive information may also include information describing individual components of the item such as, e.g., part number, dimensions, repair cost, replacement cost, and so forth. Having identified the damaged item, the item identifier may select one or more of the damaged item images 918 depicting that item to present to the user.

The repair cost generator 909, in this example, may be configured to generate an estimated cost to repair the damaged item based on the images selected at the damage information collection device 904. The repair cost generator 909 may retrieve the damage information 916 from the damage information data store 912 that indicate the images selected as best representing the damage to the item. The repair cost generator 909 may then retrieve the repair cost data 920 associated with the selected images from the damaged item image data store 914. The repair cost generator 909 may then generate an estimated cost to repair the item based on the repair cost data 920 retrieved, e.g., by summing the repair cost data.

By obtaining pre-stored images of damaged items that depict various degrees of damage to an item and allowing a claimant to select the image that best represents the actual damage to an insured item, an insurance company may advantageously obtain damage information and a corresponding repair cost without inspecting the item. Furthermore, the feedback loop described above may be leveraged to obtain the images depicting damage to the items and the corresponding cost to repair the damage. In one example scenario, an insurance company may receive a selection of a set of images selected by a claimant as best depicting the actual damage that has occurred to a vehicle. The insurance company may generate a repair cost amount based on the repair cost data associated with the selected images. During the repair process, the repair service provider may capture images of the actual damage to the item and include those captured images in the feedback provided to the insurance company along with the actual repair cost to repair the damage. The insurance company may then update the pool of damaged item images and associated repair cost data based on the feedback received from the repair service providers. The images received from the repair service providers of actual damage may thus appear in a set of damaged item images presented to a subsequent claimant for the same type of damaged item.

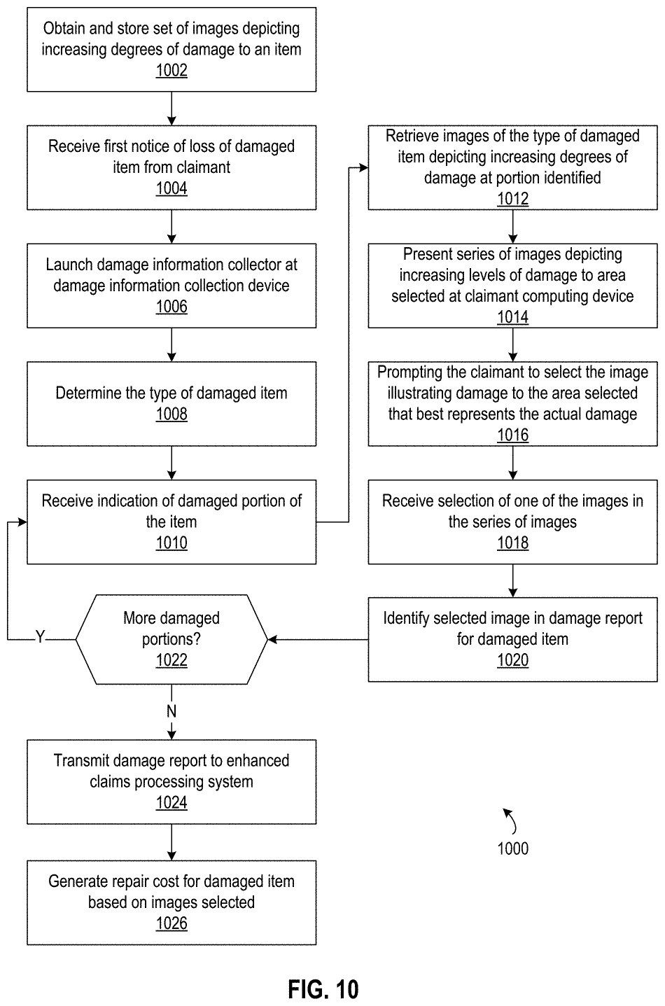

In FIG. 10, a flowchart 1000 of example method steps for collecting damage information related to a damaged item in accordance with at least one aspect of the present disclosure is shown. A set of images respectively depicting increasing degrees of damage to an item may be obtained and stored at an enhanced claims processing system (block 1002). The enhanced claims processing system may receive a first notice of loss from a claimant regarding damage to an item (block 1004) such as a vehicle. A damage information collector may be launched at a damage information collection device (block 1006) operated by the claimant. The type of damaged item may be determined (block 1008), e.g., automatically by the enhanced claims processing system or via information received from the claimant indicating the type of damaged item.

The enhanced claims processing system may also receive an indication of the damaged portion of the item (block 1010), e.g., a damaged area or a damaged component. The enhanced claims processing system may then retrieve a series of images depicting increasing degrees of damage to an item of the same type at the portion identified (block 1012). That set of images may then be presented to the claimant (block 1014) and made available for selection. The claimant may then be prompted to select which of the images presented best represents the damage that occurred to the damaged item at the portion identified (block 1016). A selection of one of the images may be received from the claimant (block 1018), and that selection may be identified in a damage report prepared for the damaged item (block 1020). The damage information collector at the damage information collection device may be configured to prepare the damage report for the damaged item. If there are additional portions of the damaged item to indicate (block 1022:Y), then the damage information collector may receive an additional selection indicating another portion of the item that was damaged, and these steps may be repeated to obtain a selection of an image that best represents the damage to that other portion.

Once no more portions of the damaged item remain to be identified (block 1022:N), the damage information collector may transmit the damage report to the enhanced claims processing system (block 1024). The damage report may include unique identifiers respectively associated with the images selected by the claimant at the damage information collector. The enhanced claims processing system may store damage information at a data store that corresponds to the damage report received. The enhanced claims processing system may then generate a repair cost based on the images selected by the claimant as best representing the damage to the item (block 1026). In this way, an insurance system may advantageously generate a repair cost for the damage item without having inspected the damaged item. An insurance company may employ the approach described above in situations where it would be difficult or cost-prohibitive to have an inspector examine the damage to the item.

Aspects of the disclosure have been described in terms of illustrative embodiments thereof. Numerous other embodiments, modifications, and variations will occur to persons of ordinary skill in the art from a review of this disclosure. For example, one of ordinary skill in the art will appreciate that the steps discussed herein may be performed in other than the recited order, and that one or more steps may be optional in accordance with aspects of the disclosure.

1. A computer-implemented method of estimating a cost to repair a damaged vehicle comprising:
automatically receiving, by a computing device from a telematics device associated with a first vehicle involved in an accident and based on detection of impact parameters by the telematics device, telematics information indicating a first notice of loss associated with the first vehicle, wherein the telematics information comprises a vehicle identifier associated with the first vehicle and one or more of an indication of speed, an indication of braking, or an indication of acceleration of the first vehicle for a time period immediately preceding and immediately subsequent to the accident;
determining, by the computing device and based on the telematics information, that the accident caused damage to the first vehicle;
automatically determining, by the computing device and based on the vehicle identifier associated with the first vehicle, a vehicle type of the first vehicle;
causing, by the computing device, a damage information collector residing at a damage information collection device operated by a user associated with the first vehicle, to present, on a screen of the damage information collection device, a plurality of user interface elements, wherein each user interface element of the plurality of user interface elements is associated with a corresponding portion of the first vehicle;
receiving, by the computing device and from the damage information collector, an indication of a selected user interface element of the plurality of user interface elements, wherein the selected user interface element corresponds to a damaged portion of the first vehicle;
selecting, by the computing device and based on the indication of the selected user interface element, a plurality of pre-stored images of a damaged reference vehicle of the same vehicle type as the first vehicle, wherein the plurality of pre-stored images depict different degrees of damage to a damaged portion of the damaged reference vehicle, wherein the damaged portion of the damaged reference vehicle is substantially the same as the damaged portion of the first vehicle, and wherein each pre-stored image of the plurality of pre-stored images is associated with an indication of an estimated cost to repair or replace the damaged portion of the damaged reference vehicle;
causing, by the computing device, the damage information collector to present, on the screen of the damage information collection device, the plurality of pre-stored images;
receiving, by the computing device and from the damage information collector, an indication of a selected pre-stored image of the plurality of pre-stored images;
generating, by the computing device and based at least in part on the indication of the estimated cost associated with the selected pre-stored image, a first total estimated cost to repair or replace the first vehicle;
receiving, by the computing device, one or more images depicting at least a portion of the damage to the first vehicle and an indication of an actual cost to repair or replace at least a portion of the first vehicle;
updating, by the computing device and based on the indication of the actual cost to repair or replace at least a portion of the first vehicle, at least one indication of the estimated cost to repair or replace the damaged portion of the damaged reference vehicle that is associated with the plurality of pre-stored images of the damaged reference vehicle to obtain at least one improved indication of the estimated cost to repair or replace the damaged portion of the damaged reference vehicle; and
generating, by the computing device and based at least in part on the improved indication of the estimated cost to repair or replace the damaged portion of the damaged reference vehicle, a second total estimated cost to repair or replace a second vehicle of the same type as the first vehicle.

2. The computer-implemented method of claim 1, further comprising:
causing, by the computing device, the damage information collector to present, on the screen of the damage information collection device, a plurality of additional user interface elements, wherein the plurality of additional user interface elements indicate different types of damage; and
receiving an indication of one or more of selected additional user interface elements of the plurality of additional user interface elements, wherein the one or more selected additional user interface elements indicate one or more types of damage that occurred to the first vehicle.

3. The computer-implemented method of claim 2, further comprising:
storing, for each pre-stored image of the plurality of pre-stored images, metadata comprising the vehicle type of the reference vehicle, and an identifier of the portion of the damaged reference vehicle depicted.

4. (canceled)

5. The computer-implemented method of claim 1, further comprising:
receiving an indication of a second selected pre-stored image, of a second plurality of pre-stored images depicting damage to the damaged reference vehicle, that corresponds to damage to a second damaged portion of the first vehicle, wherein the generating the first total estimated cost to repair or replace the first vehicle comprises summing the estimated cost associated with the selected pre-stored image of the plurality of pre-stored images and an estimated cost associated with the second selected pre-stored image of the second plurality of pre-stored images.

6. The computer-implemented method of claim 1, wherein:
the plurality of pre-stored images depict types of damage to an area of the damaged reference vehicle.

7. The computer-implemented method of claim 1, wherein:
the plurality of pre-stored images depict types of damage to a component of the damaged reference vehicle.

8. The computer-implemented method of claim 1,
wherein a subsequent image in the plurality of pre-stored images depicts more damage to the damaged reference vehicle relative to a previous image in the plurality of pre-stored images that precedes the subsequent image.

9. The computer-implemented method of claim 1, wherein:
the plurality of pre-stored images comprise a plurality of photos of the damaged reference vehicle.

10. The computer-implemented method of claim 1, wherein:
the plurality of pre-stored images comprise a plurality of graphical representations of the damaged reference vehicle.

11. (canceled)

12. The computer-implemented method of claim 1, further comprising generating a damage report that comprises the first total estimated cost.

13. The computer-implemented method of claim 1, wherein the portion of the first vehicle is selected from the group consisting of:
a side or side area of the first vehicle,
a panel or panel area of the first vehicle,
a window or window area of the first vehicle,
a door or door area of the first vehicle,
a wheel or wheel area of the first vehicle,
a mirror or mirror area of the first vehicle,
a hood or hood area of the first vehicle,
a trunk or trunk area of the first vehicle, and
a bumper or bumper area of the first vehicle.

14. A system for estimating a cost to repair a damaged vehicle comprising:
a telematics device associated with a first vehicle involved in an accident, the telematics device configured to detect impact parameters, and to automatically transmit, based on detection of the impact parameters, telematics information indicating a first notice of loss associated with the first vehicle, wherein the telematics information comprises a vehicle identifier associated with the first vehicle and one or more of an indication of speed, an indication of braking, or an indication of acceleration of the first vehicle for a time period immediately preceding and immediately subsequent to the accident;
a data store that stores a plurality of pre-stored images depicting varying degrees of damage to a damaged portion of a damaged reference vehicle, wherein each pre-stored image of the plurality of pre-stored images is associated with an indication of an estimated cost to repair or replace the damaged portion of the damaged reference vehicle; and
a computing device configured to:
automatically receive, from the telematics device, the telematics information,
determine, based on the telematics information, that the accident caused damage to the first vehicle,
automatically determine, based on the vehicle identifier associated with the first vehicle, a vehicle type of the first vehicle,
cause a damage information collector residing at a damage information collection device operated by a user associated with the first vehicle, to present on a screen of the damage information collection device, a plurality of user interface elements, wherein each user interface element of the plurality of user interface elements is associated with a corresponding portion of the first vehicle,
receive, from the damage information collector, an indication of a selected user interface element of the plurality of user interface elements, wherein the selected user interface element corresponds to a damaged portion of the first vehicle,
select, based on the indication of the selected user interface element, the plurality of pre-stored images of the damaged portion of the damaged reference vehicle of the same vehicle type as the first vehicle, wherein the damaged portion of the damaged reference vehicle is substantially the same as the damaged portion of the first vehicle,
cause the damage information collector to present, on the screen of the damage information collection device, the plurality of pre-stored images,
receive, from the damage information collector, an indication of a selected pre-stored image, of the plurality of pre-stored images,
generate, based on at least in part on the indication of the estimated cost associated with the selected pre-stored image, a first total estimated cost to repair or replace the first vehicle,
receive one or more images depicting at least a portion of the damage to the first vehicle and an indication of an actual cost to repair or replace at least a portion of the first vehicle,
update, based on the indication of the actual cost to repair or replace at least a portion of the first vehicle, at least one indication of the estimated cost to repair or replace the damaged portion of the damaged reference vehicle that is associated with the plurality of pre-stored images of the damaged reference vehicle to obtain at least one improved indication of the estimated cost to repair or replace the damaged portion of the damaged reference vehicle, and
generate, based at least in part on the improved indication of the estimated cost to repair or replace the damaged portion of the damaged reference vehicle, a second total estimated cost to repair or replace a second vehicle of the same type as the first vehicle.

15. The system of claim 14, wherein:
the data store stores, for each pre-stored image of the plurality of pre-stored images, metadata comprising a vehicle type of the reference vehicle, and an identifier of the portion of the damaged reference vehicle depicted.

16. (canceled)

17. The system of claim 14, wherein:
the computing device is further configured to
receive an indication of a second selected pre-stored image, of a second plurality of pre-stored images depicting damage to the damaged reference vehicle, that corresponds to damage to a second damaged portion of the first vehicle; and
generate the first total estimated cost to repair or replace the first vehicle by summing at least the estimated cost associated with the selected pre-stored image of the plurality of pre-stored images and an estimated cost associated with the second selected pre-stored image of the second plurality of pre-stored images.

18. The system of claim 14, wherein:
the plurality of pre-stored images comprise a plurality of photos of the damaged reference vehicle.

19. The system of claim 14, wherein:
the plurality of pre-stored images comprise a plurality of graphical representations of the damaged reference vehicle.

20. (canceled)

21. A non-transitory computer readable medium storing instructions that, when executed by one or more processors, cause:
automatically receiving, from a telematics device associated with a first vehicle involved in an accident, and based on detection of impact parameters by the telematics device, telematics information indicating a first notice of loss associated with the first vehicle, wherein the telematics information comprises a vehicle identifier associated with the first vehicle and one or more of an indication of speed, an indication of braking, or an indication of acceleration of the vehicle for a time period immediately preceding and immediately subsequent to the accident;
determining, based on the telematics information, that the accident caused damage to the first vehicle;
automatically determining, based on the vehicle identifier associated with the first vehicle, a vehicle type of the first vehicle;
causing a damage information collector residing at a damage information collection device operated by a user associated with the first vehicle, to present, on a screen of the damage information collection device, a plurality of user interface elements, wherein each user interface element of the plurality of user interface elements is associated with a corresponding portion of the first vehicle;
receiving, from the damage information collector, an indication of a selected user interface element of the plurality of user interface elements, wherein the selected user interface element corresponds to a damaged portion of the first vehicle;
selecting, based on the indication of the selected user interface element, a plurality of pre-stored images of a damaged reference vehicle of the same vehicle type as the first vehicle, wherein the plurality of pre-stored images depict different degrees of damage to a damaged portion of the damaged reference vehicle, wherein the damaged portion of the damaged reference vehicle is substantially the same as the damaged portion of the first vehicle, and wherein each pre-stored image of the plurality of pre-stored images is associated with an indication of an estimated cost to repair or replace the damaged portion of the damaged reference vehicle;
causing, the damage information collector to present, on the screen of the damage information collection device, the plurality of pre-stored images;
receiving, from the damage information collector, an indication of a selected pre-stored image, of the plurality of pre-stored images;
generating, based on at least in part on the indication of the estimated cost associated with the selected pre-stored image, a first total estimated cost to repair or replace the first vehicle;
receiving one or more images depicting at least a portion of the damage to the first vehicle and an indication of an actual cost to repair or replace at least a portion of the first vehicle;
updating, based on the indication of the actual cost to repair or replace at least a portion of the first vehicle, at least one indication of the estimated cost to repair or replace the damaged portion of the damaged reference vehicle that is associated with the plurality of pre-stored images of the damaged reference vehicle to obtain at least one improved indication of the estimated cost to repair or replace the damaged portion of the damaged reference vehicle; and
generating, based at least in part on the improved indication of the estimated cost to repair or replace the damaged portion of the damaged reference vehicle, a second total estimated cost to repair or replace a second vehicle of the same type as the first vehicle.

22-24. (canceled)

25. The computer-implemented method of claim 1, wherein the plurality of pre-stored images are presented as selectable user interface elements.

26. The system of claim 14, wherein the plurality of pre-stored images are presented as selectable user interface elements.

27. The non-transitory computer readable medium storing instructions of claim 21, wherein the plurality of pre-stored images are presented as selectable user interface elements.
